(19) United States
(12) Patent Application Publication
(10) Pub. No.: US 2026/0172341 A1
(43) Pub. Date: Jun. 18, 2026

(54) OUTCOME-MAPPED DECISION MODEL FOR NETWORK ROUTING

(71) Applicant: Stripe Inc., South San Francisco, CA (US)

(72) Inventors: Joshua Ackerman, San Francisco, CA (US); Andrei Zaharia, Bellevue, WA (US); Michael Cribbin, Greystones (IE); Niall O'Hara, Castlebar (IE); Aidan Foley, Dublin (IE); Cody Ley-Han, Seattle, WA (US)

(73) Assignee: Stripe Inc., South San Francisco, CA (US)

(21) Appl. No.: 18/979,358

(22) Filed: Dec. 12, 2024

(51) Int. Cl. H04L 45/12; G06F 8/65; H04L 41/16; H04L 45/02

(52) U.S. Cl. CPC H04L 45/124; G06F 8/65; H04L 41/16; H04L 45/02

(57) ABSTRACT

A method and related systems may generate and use a machine learning model that determines multiple outcome values for multiple message routes. Some embodiments may then compare the multiple outcome values to select a target route for the message. Moreover, some embodiments may facilitate routing through one or more networks by mapping aggregated performance metrics through controlled nodes.

### SUMMARY

Effective routing is important to ensure reliable and efficient network communication. Suboptimal routing can lead to performance issues like increased latency and congestion. However, suboptimal routing can occur even when individual routing decisions are theoretically optimal at each node of the route due to a failure to account for aggregate effects.

Some embodiments may perform operations to reduce latency and increase messaging throughput into intended destinations by mapping aggregated performance metrics through nodes of a network. For example, a computer system may receive instructions to train a predictive neural network to predict resource utilization of a particular route from a starting point of a route to an ending point of the route. In response, some embodiments may generate a routing tree by mapping, at each layer of a possible route, the route options available at that layer to nodes of the routing tree. Some embodiments may then determine a set of performance metrics associated with the routing tree by, for each respective route of the routing tree, traversing to a respective leaf node of the routing tree to determine a respective total performance metric of the respective route. This routing tree may act as a model of reasonably possible decisions and reasonably possible outcomes and be used to map out multiple outcomes from a single starting point. Some embodiments may use this model to determine the best combination of route options for a message to take and provide commands to control route direction to reduce latency or satisfy some other set of performance criteria.

After generating the routing tree, some embodiments may train, based on different routing tree states of the routing tree, a neural network or other machine learning model to predict performance metrics by using the set of performance metrics as training data. Some embodiments may then deploy, via a network, one or more portions of the machine learning model to a computing system to update a distributed version of the machine learning model. By using this deployed model in lieu of a full routing model, some embodiments may effectively use the guidance of the routing model to process hundreds of thousands or even millions of transactions concurrently.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an example system for determining a network route through a network by mapping aggregated performance metrics, in accordance with one or more embodiments.

FIG. 2 shows an example architecture for determining a route based on performance metrics, in accordance with one or more embodiments.

FIG. 3 shows a conceptual diagram of a routing tree used to determine a route based on performance metrics, in accordance with one or more embodiments.

FIG. 4 shows a flowchart of a process for determining a route based on performance metrics, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

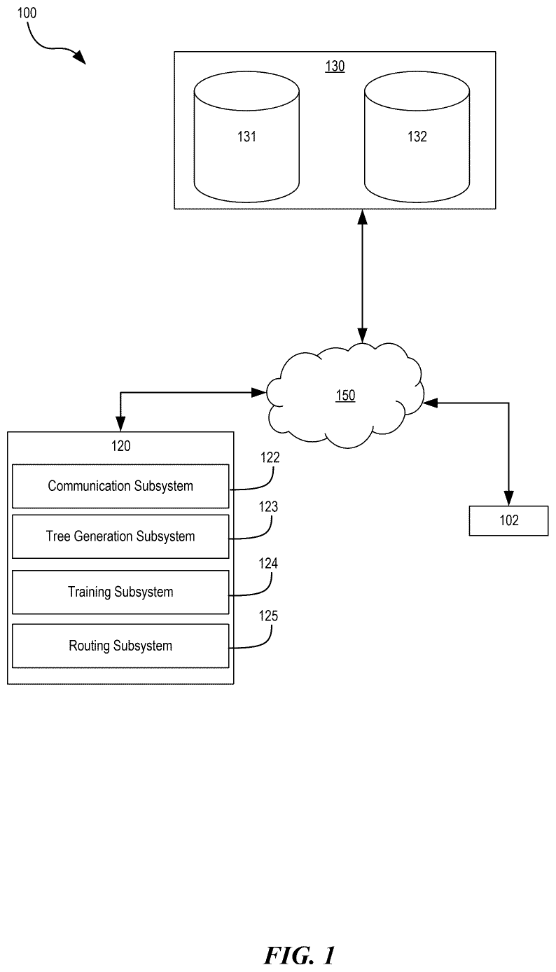

FIG. 1 shows an example system 100 for determining a network route through a network by mapping aggregated performance metrics, in accordance with one or more embodiments, in accordance with one or more embodiments. A system 100 includes a client device 102 in communication with a server 120 via a network 150. As will be described further in this disclosure, the server 120 may perform operations to select a route for a message traversing a network by analyzing outcomes associated with multiple candidate routes.

In some embodiments, the system 100 may determine a set of route options for a message and then generate a routing tree to represent the various combinations of route options that can form a route. A route option may include or represent one or more available actions that a system may take with respect to a message, such as sending the message to another physical or virtual node of a computer network, processing the message, transforming the message, performing an action based on the message, etc. By generating or updating a routing tree based on the route options, some embodiments may capture the various types of routes through which a message may take and provide a full set of training data for route determination operations. After generating the routing tree, some embodiments may then traverse the various routes of the routing tree to determine performance metrics for the routes and train one or more prediction layers of a prediction model to predict outcomes and select routes for messages. Some embodiments may then deploy the prediction layers (or portions thereof) to one or more computer systems for use.

In some embodiments, the system 100 may receive instructions to generate or update a model to determine message routes and, in response, generate a routing tree to represent the various combination of route options that can form a route for the message. Some embodiments may then, for each respective route of the routing tree, traverse through the respective set of nodes of the respective route to determine a corresponding set of metrics and determine aggregated metrics based on the corresponding set of metrics. For example, some embodiments may determine, for each respective route, a total latency, total network cost, total computing resource cost, a count of or likelihood of using authentication operations, etc. By mapping each outcome to a route, some embodiments may determine the route or set of routes that may provide a most favorable outcome which may otherwise be closed off due to a premature action. After determining the routing tree and outcome values of the routing tree routes, some embodiments may then train a neural network or other prediction model to predict the routing tree outcome values based on routes of the routing tree. Some embodiments may then deploy the neural network or other prediction model for use in routing a message through a network.

In some embodiments, the system 100 may update a machine learning model to select the route options of a message route. The system 100 may generate a routing tree and traverse through the routes of the routing tree to determine metrics associated with the routes. Some embodiments may then train a prediction layer (e.g., a neural network layer or set of neural network layers) so that the prediction layer may be used to predict outcome values or other data related to one or more routes. By using the trained prediction model, some embodiments may provide a means of quickly determining which route is likely to yield a target outcome, such as an outcome below a risk threshold or an outcome below a latency threshold.

The client device 102 may include one of various types of computing devices, such as a laptop, a tablet, a desktop, a payment kiosk, a payment terminal, a smartphone, etc. The client device 102 may send requests, responses, or other messages to the server 120 that may require communication with other computing devices or other electronic devices. Additionally, the server 120 may include various types of computing units, such as physically separate servers, virtual nodes hosted on one or more physical machines, or nodes on a cloud computing system. Applications, services, or other operations may use data provided by the client device 102, the server 120, or a set of databases 130 that includes a first networked database 131 and a second networked database 132. The set of databases 130 may include various types of databases, such as SQL databases, no SQL databases, graph databases, etc. In some embodiments, the server 120 may perform one or more operations related to a communication subsystem 122, a tree generation subsystem 123, a training subsystem 124, or a routing subsystem 125.

In some embodiments, the communication subsystem 122 may obtain program instructions, commands, queries, parameters, values, or other data from the client device 102 that may cause the retrieval of attribute descriptors, the generation of an input, or the execution of a command. For example, the communication subsystem 122 may receive requests to execute a database transaction from the client device 102 that causes the server 120 to query the set of databases 130. Furthermore, operations performed by the server 120 may use the communication subsystem 122 to send messages to the set of databases 130, the client device 102, or another computing device described in this disclosure. For example, the communication subsystem 122 may send out queries from the server 120 to the set of databases 130.

In some embodiments, the tree generation subsystem 123 may generate a routing tree based on a set of route options corresponding with a set of controlled nodes from a starting node of the routing tree. For example, some embodiments may gather eligible actions from various domains and possible states (e.g., doing nothing, blocking a message, using an authentication engine, using an image-based verification engine, using SMS verification, etc.). Some embodiments may further collect logged metrics or other data associated with eligible actions. Based on the collected values, some embodiments may construct a routing tree for a message.

In some embodiments, the tree generation subsystem 123 may traverse each respective route of the routing tree to a respective leaf node of the routing tree to determine a respective total performance metric associated with the respective route. The tree generation subsystem 123 may then determine a set of performance metrics associated with the routing tree and use this set of performance metrics to determine outcome values. Some embodiments may determine a set of routing tree states associated with different routes, where a routing tree state may include a route and an outcome value or other outcome indicators associated with the route. For example, a route may be represented as a sequence of nodes, and a routing tree may include both the route and an outcome value of the leaf node of the sequence of nodes. Furthermore, some embodiments may establish a default action to take at each node, which may help with establishing offline fallback behaviors.

In some embodiments, the training subsystem 124 may train a prediction model (e.g., a set of prediction layers, a full predictive neural network, etc.) to predict performance metrics by using the set of performance metrics as training data. The training subsystem 124 may train a machine learning model to predict outcome values associated with one or more routes mapped to a routing tree. Various types of machine learning models may be trained and may include multiple types of machine learning models. For example, some embodiments may use a mixture-of-experts machine learning model that includes a set of neural networks, random forest, etc.

In some embodiments, establishing or using a model may include filtering out actions that cannot be performed (e.g., due to external constraints). For example, some embodiments may perform testing limits, limit node weight values, limits on a number of retries, etc. Such filtering may permit standardization of an initial approach that is still adaptable to different regions or sets of constraints. Various types of models may be used, such as binary classification models to predict a single likelihood or a more complex model that may include a combination of online and offline machine learning stacks. For example, some embodiments may use a multi-gate mixture of experts multi-task model architecture to predict probabilities or recommend route options of a routing tree.

In some embodiments, the routing subsystem 125 may use a trained prediction layer (e.g., a trained set of neural network layers) to determine outcome values for different possible routes. The routing subsystem 125 may then direct a set of messages through one or more routes associated with a corresponding aggregated outcome value associated with the one or more routes. A prediction layer may perform operations such as determining a route cost, a probability of successful authorization, or a probability of a malicious activity related to a route (e.g., a probability of a network security issue associated with the route, fraud probability associated with the route, etc.).

In some embodiments, the routing subsystem 125 may include a randomization policy, such as a policy that includes a SoftMax component or Thompson-sampling component. The routing subsystem may use a trained model to predict multiple outcome possibilities using a prediction layer, such as a multi-task mixture-of-experts machine learning model. Some embodiments may use this prediction model to predict values such as a malicious activity probability (e.g., probability of a network security issue, fraudulent message probability, etc.), a message failure likelihood if a route involves performing one or more authentication operations, an updated probability of malicious activity after a set of authentication criteria is satisfied, a network cost, etc.

By using a single machine learning model that is executed at a start, some embodiments may reduce the number of sequential calls to a machine learning model. For example, in contrast to a system that makes sequential calls to determine whether to (1) label a message at a first gateway as being malicious (e.g., labeling an email, SMS, or other communication message as a scam or phishing attempt, labeling content or an attachment as including malware or a hyperlink to such malware, labeling a transaction request as fraudulent, etc.), (2) decline a message, (3) validate a message format or value, or (4) perform an authentication operation, some embodiments may perform a machine learning model operation that retrieves all these values and other values at once, thus reducing the total number of calls to a decision subsystem.

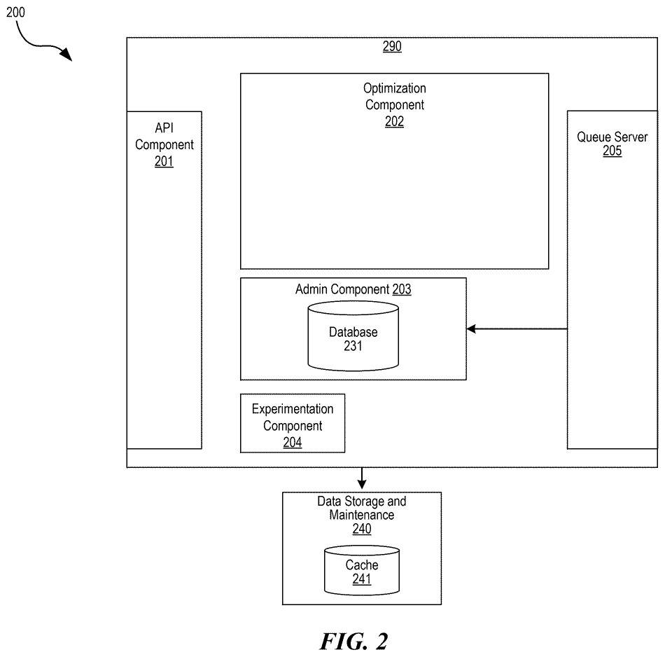

FIG. 2 shows an example architecture for determining a route based on performance metrics, in accordance with one or more embodiments. Some embodiments, a system 200 includes an optimization engine 290, where the optimization engine 290 includes an API component 201, an optimization component 202, an admin component 203, an experimentation component 204, a queue server 205, or other components.

In some embodiments, the optimization component 202 may determine what eligible operations may be performed, such as authorization operations or authentication operations. The optimization component 202 may also evaluate operations and score the viability of these operations. For example, some embodiments may score operations based on a set of malicious-activity-detection criteria and remove pathways to performing such operations (which may be reflected by constructing a routing tree that does not include route options representing these operations). In some embodiments, the optimization component 202 may also execute a machine learning model to score a route, determine costs associated with that route (e.g., computing costs, network resource costs, other types of costs) or determine metrics associated with the route (e.g., determine an expected profit). In some embodiments, the optimization component 202 may apply user-specific configuration or updates to a machine-learning model, such as determining whether a malicious-activity-related tolerance is satisfied, a profit margin threshold is satisfied etc. Furthermore, the optimization component 202 may determine options with a strong degree of granularity. For example, some embodiments may determine what verification options (e.g., three-dimensional secure (“3DS”), specific types of 3DS options, image-based verification, etc.) are available for use based on a device type that sent a message, existing certification, issuer supportability, etc.

The optimization component 202 may also disqualify or remove route options, which may cause the optimization component 202 to remove or not include leaf nodes in a corresponding routing tree. For example, some embodiments may determine that a set of authentication operations are disqualified for certain message types, such as determining that 3DS-related operations are not available based on a message type associated with a message. Some embodiments may refer to a data structure, such as an enumerated list, to determine which route options should be removed or not used when generating or updating a route for a message. In some embodiments, the optimization component 202 may filter routes so that a subset of routes is removed or a subset of routes is permitted. For example, some embodiments may generate the optimization component 202 to satisfy a user-provided criterion that only routes that include a 3DS challenge operation are permitted.

In some embodiments, the optimization component 202 may perform network token pre-fetching operations and perform other operations related to network tokens. For example, the optimization component 202 may determine, using a machine learning model or another component, that a target outcome (e.g., a highest-profit outcome) is associated with the use of a network token. In response, some embodiments may check if the network token is ready and, if not, route a message through the route having the highest value that does not include a network token (e.g., a route that includes 3DS verification, a route with direct-to-authorization (D2A) with personal account number (PAN) verification, etc.).

In some embodiments, the optimization component 202 may train or use a prediction layer that includes a set of machine learning models. For example, some embodiments may use a multi-task model, where the architecture of the multi-task model. In some embodiments, the multi-task model should permit multiple sequential model calls and multiple parallel requests for that model. Some embodiments may use a model that may take into account multiple parameters. For example, some embodiments may generate a routing tree that includes a route option to another network that will have (1) a first network cost if authentication has been performed and will have (2) a second network cost if the authentication has not been performed. In some embodiments, the optimization component 202 may first predict a probability value of authentication (e.g., a probability value labeled “P(3Ds_is_triggered)”) and then use it to determine corresponding outcome scores using the probability value for both the first network cost and the second network cost.

As another example, some embodiments may first determine a set of candidate actions and filter the set of candidate actions into permitted actions acceptable to a region or operating environment (e.g., compatible with network or other technical requirements of one or more server clusters or systems via which the actions are to be processed, compliant with requirements of one or more geographical regions in which the actions are to be processed, etc.). Some embodiments may then obtain a message that includes or is associated with a set of input features, such as features related to the message issuer, features related to contents of the message (e.g., a transaction value of a transaction), etc. Some embodiments may obtain a machine learning model trained to predict outcomes associated with action sequences of the set of candidate actions. Some embodiments may then provide input features associated with a multi-task model to obtain a set of probability values based on the input features, such as a probability of conversion, probability of message decline, probability of a message retry event, and probability of an authentication operation, where such probability values may correspond with each possible outcome of a set of outcomes (e.g., outcomes represented by a leaf node of a routing tree). From these direct outputs, some embodiments may determine, for use as an outcome-characterizing value, an objective function value, such as a profit amount, a network cost amount, a likelihood of a malicious activity, etc. Some embodiments may then sort these objective function values or otherwise compare the various outcome values and either select the route for a message to take based on a corresponding maximum value (or a corresponding minimum value, if a minimum score is desirable, such as in the case of cost).

As another example, some embodiments may determine a route for routing a device access request (e.g., a most optimal route based on one or more optimization criteria) by first determining a set of candidate actions for processing the device access request, such as (i) performing one or more authentication methods (e.g., routing the request via a third-party authenticator system, performing SMS or email verification, etc.), (ii) validating the request (e.g., verifying that the request satisfies predefined structural and semantic criteria before the request is further processed by the system or one or more applications), (iii) sending the request to one or more gateways or other type of nodes (e.g., routing the request to a third-party service hosting a device to be accessed or enables remote access capabilities to the device or one or more applications of the device), or (iv) other actions. Some embodiments may obtain a machine learning model trained to predict outcomes associated with action sequences of the set of candidate actions. Some embodiments may then obtain input features indicating request content of the request, request format of the request, and encryption type used to encrypt the request. Some embodiments may then provide these input features to a multi-task model to obtain a set of probability values related to malicious activity, spam, or device error, where such probability values may correspond with each possible outcome of a set of outcomes. The outcome values characterizing an outcome may include a first score calculated with a first objective function indicating a likelihood of message authenticity and a second score calculated with a second objective function indicating a score of message priority for device health. Some embodiments may then sort these objective function values or otherwise compare the various outcome values and select the route for a message that satisfies a minimum threshold for message authenticity likelihoods and a minimum threshold for message priority scores.

As another example, some embodiments may determine a route for routing a transaction request associated with a merchant or other user (e.g., a most optimal route for a transaction request related to a transaction involving a customer purchasing products or services from the merchant) by first determining a set of candidate actions for processing transaction requests, such as (i) one or more gateways for processing the transaction request (e.g., selecting third-party gateway or other gateway that supports one or more authentication methods to be employed), (ii) one or more transaction authentication operations (e.g., use of PAN, a specific network token, 3DS, D2A, authentication methods used for content or device access requests described herein, or other authentication operations), (iii) rejecting a transaction request, or other actions. Some embodiments may obtain a machine learning model trained to predict outcomes associated with action sequences of the set of candidate actions. Some embodiments may then obtain input features indicating a transaction amount of the transaction request, transaction participant identifiers transaction request, encryption type of the transaction request, etc. Some embodiments may then provide these input features to a multi-task model to obtain a set of probability values related to malicious activity, network cost, payoff likelihood, expected payoff amount, etc. Some embodiments may then select the most desirable outcome as defined by a user (e.g., greatest expected payoff value, lowest malicious activity likelihood (e.g., lowest fraud likelihood), lowest monetary or other cost, etc., where the user is a merchant or other entity) and then select the route that causes a computer system to process a message in accordance with the route. For example, a computer system may provide a machine learning model with message data for a message to determine that, amongst the outcome scores for a set of routes, a first route (e.g., including one or more gateways or other nodes or systems via which the transaction is to be routed) is associated with the greatest payoff value. In response, the computer system may execute operations of the first route, where the sequence of actions for this route may include sending a transaction request to a first gateway in lieu of other gateways, generating an inferred zip code for the transaction, forcing a 3DS authentication operation that will prompt the user for a code, and validating the result.

In some embodiments, the admin component 203 may permit the updating of and management of user-level personalization for optimization operations. For example, some embodiments may support a configurable profit margin, tolerance for latency, tolerance for malicious activity, and transaction risk analysis exemption, etc. For example, the admin component 203 may receive user messages controlling a latency tolerance and modify which outcomes and routes are viable for a message based on the latency tolerance. In some embodiments, the admin component 203 may expose an endpoint to permit queries indicating the status of a user (e.g., enrollment status, activity status, etc.).

In some embodiments, the admin component 203 may receive a list of candidate routes through a routing tree. In some embodiments, the optimization component 202 may then use these candidate routes in conjunction with message-related data to select which of the candidate routes to use as the target route for routing a message. Furthermore, the optimization component 202 may use the objective function to determine an outcome score used to select the candidate route. In some embodiments, the optimization component 202 may determine score determination may be performed asynchronously and retrieved during actual operations. The admin component 203 may also store user settings for specific users in a database 231, such as data related to a user-defined maximum cost threshold, a user-defined maximum latency threshold, etc.

In some embodiments, the experimentation component 204 may be used to modify or override parameters of other subsystems of the system 200 to enable changing message routes to routes that are not an original target route. For example, some embodiments may use the experimentation component 204 to initiate Thompson sampling operations to compare different sets of routes to validate the effectiveness of a target route over a non-target route, where the majority of messages may be routed over the target route, and a smaller number of messages may be routed over the non-target route. In some embodiments, the experimentation component 204 may observe, log, and alert operations based on message routes and outcomes of message routes.

In some embodiments, messages and message-related data may be received by an API component 201 of the system 200. For example, the API component 201 may obtain action-related information associated with a message, such as user identifiers of a user initiating the message, a device identifier of a device used to obtain the message, other types of identifiers, L3 data related to L3 transactions, etc. The API component 201 may then provide some or all of the received data to other components of the system 200.

In some embodiments, the system 200 may include a queue server 205, where the queue server 205 may act as a middleware layer with external computer systems. For example, the queue server 205 may perform message buffering during peak loads or connectivity issues, ensuring ordered processing to prevent lost messages, managing automatic retries of messages that are rejected or failed to reach a target destination, etc. In addition, the queue server 205 may handle maintaining message records for system recovery and log events for tracking and performance monitoring.

In some embodiments, the data storage and maintenance subsystem 240 may receive outputs. For example, the data storage and maintenance subsystem 240 may receive outputs from the optimization component 202, the admin component 203, or the experimentation component 204. Some embodiments may store output data in a cache 241, which may permit easy retrieval of one or more values used or described in this disclosure. For example, some embodiments may retrieve from the cache 241, outcome scores, machine learning model parameters for one or prediction layer, metrics, etc.

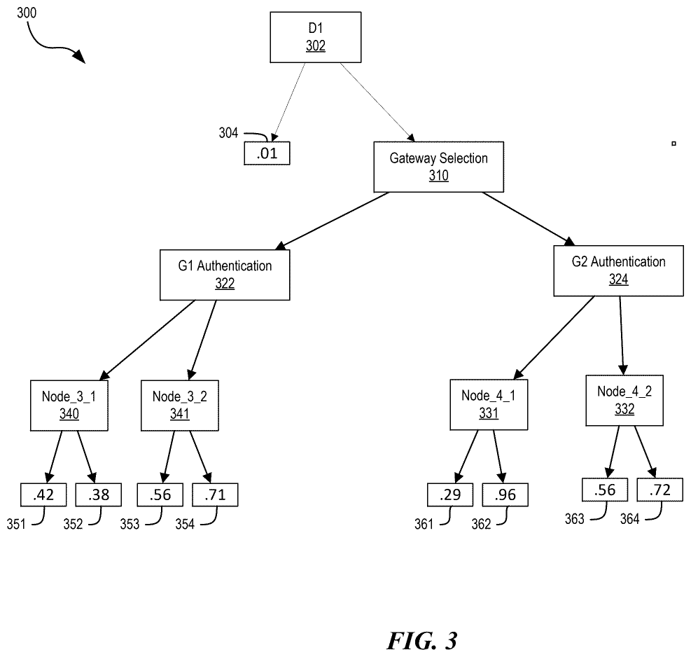

FIG. 3 shows a conceptual diagram of a routing tree 300 used to determine a route based on performance metrics, in accordance with one or more embodiments. Some embodiments may generate the routing tree 300 and use this routing tree to evaluate outcomes associated with different routes. The routing tree includes node 302, node 310, node 322, node 324, nodes 340, node 341, node 331, node 332, leaf node 304, leaf node 351, leaf node 352, leaf node 353, leaf node 354, leaf node 361, leaf node 362, leaf node 363, and leaf node 364. As shown by the routing tree 300, the node 302 may point to either the leaf node 304 or the node 310. The node 310 shows that a message may be sent to a route option leading to node 322 representing a first gateway or to a path leading to node 324 representing a second gateway. The node 322 may then send or process a message based on a path to a node 340 or a path to a node 341. The node 340 itself may point to a leaf node 351 having an outcome value equal to 0.42 or a leaf node 352 having an outcome value equal to 0.38. Similarly, the node 341 itself may point to a leaf node 353 having an outcome value equal to 0.56 or a leaf node 354 having an outcome value equal to 0.71. Additionally, the node 324 may send or process a message based on a path to a node 331, where the node 331 itself may point to the leaf node 361 having an outcome value equal to 0.29 or the leaf node 362 having an outcome value equal to 0.96. Furthermore, the node 324 may then send or process a message based on a path to a node 332, where the node 332 itself may point to the leaf node 363 having an outcome value equal to 0.56 or the leaf node 364 having an outcome value equal to 0.72.

The nodes may represent physical devices or virtual devices or message routing or processing points for a message. For example, the node 302 may represent an initial decision point at a first receiving device to determine whether or not to reject the message. The node 310 may represent a node or process point for performing a gateway selection operation. In some embodiments, the routing decision may happen in milliseconds, where a goal of a decision is to maximize approval rates while minimizing costs by choosing between multiple available processing pathways. The selected gateway may handle the secure transmission of data. The node 322 may represent a first gateway, and the node 324 may represent a second gateway, where gateways represented by the node 322 and the node 324 may respond to incoming messages in various ways, such as by initializing downstream applications or services, effectuating database transactions, etc. The nodes 340 and 341 may represent different authorization operations that may be performed by a gateway represented by the node 322. For example, a gateway or decision point performed by the gateway may be represented by the node 322, and outcome decisions may include different authorization approaches and different authentication approaches. For example, a gateway may elect to use a network token (NT) as part of an authorization process or a PAN as part of the authorization process, where the selection of different authorization processes may be represented as different nodes of a routing tree. Similarly, a gateway may perform different types of authentication approaches, such as using either a D2A or initializing a more complex 3DS authorization operation.

A leaf node may represent an ending for a message route. For example, the leaf node 304 may be associated with a set of outcome values for initial rejection. An outcome value may depend on the various types of metrics being calculated, and may represent or include values related to network performance, computational resource use, expected total value or cost from a route, expected profit, etc. Furthermore, some embodiments may select a target route for a message based on the outcome values. Some embodiments may determine a target route based on determining a maximum value or minimum value associated with the different outcome values. For example, if the outcome values represent a reliability score or profit score, some embodiments may select the route for a message corresponding with the greatest outcome value. Based on this selection criteria, some embodiments may select, for a message, a route that is represented in a routing tree as a tree state that starts at the node 302, proceeds to the node 310, continues to the node 324, continues to the node 331, and ends at the leaf node 362 based on a determination that the leaf node 362 is associated with a greatest outcome value.

### Flowchart

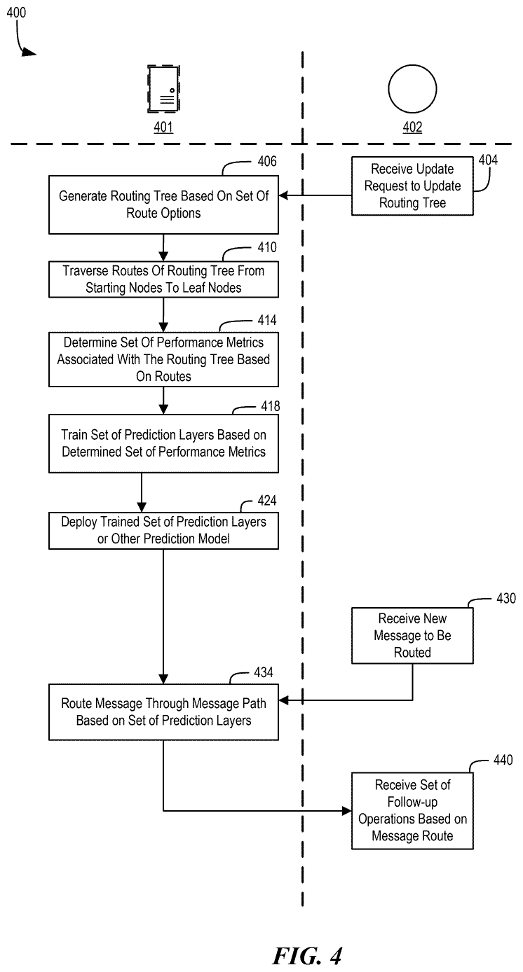

FIG. 4 shows a flowchart of a process for determining a route based on performance metrics, in accordance with one or more embodiments. The process 400 is shown as a swimlane flowchart, in which column 401 represents operations performed by a server system and column 402 represents operations performed by a client system. It should be understood that descriptions of an operation being performed by a system are exemplary and non-limiting, such that operations described as being performed by one system may instead be performed by another system unless described otherwise.

Some embodiments may receive a request involving the retrieval of data from a set of data stores, as indicated by block 404. In some embodiments, operations of the block 404 may be performed by a client system, as shown in column 402. The client system may receive instructions that cause the client system, a server system, or another computer system to perform one or more routing tree generation operations or other operations described in this disclosure.

Some embodiments may generate a routing tree based on a set of route options, as indicated by block 406. Some embodiments may determine a set of eligible actions for each unique state of a message routing operation and generate a routing tree based on these sets of eligible actions. For example, some embodiments may determine that a first set of eligible actions at a first state after receiving a message is to either accept the message or delete the message, and that a next set of eligible actions at a second state after accepting the message is to route the message to a first gateway, route the message to a second gateway, or route the message to a third gateway. Some embodiments may then generate a routing tree that includes route options representing each of these eligible actions.

Some embodiments may receive a request involving the retrieval of data from a set of data stores during a communication session between a first server and a client device, as indicated by block 410. In some embodiments, operations of the block 410 may be performed by a server system, as shown in the column 401. Some embodiments may generate a routing tree by analyzing a set of route options through a message network for the routing tree. Some embodiments may generate the routing tree by analyzing the network nodes for a network a message may traverse from a beginning node to an end node. Furthermore, a computer system may access a set of controlled nodes, where the computer system may control operations of one or more nodes of the set of controlled nodes or have access to the operations of one or more nodes of the set of controlled nodes. For example, some embodiments may control the parameters of a node that may select either a first or second gateway, where manipulation of the parameters transfers messages to the first gateway or the second gateway.

Some embodiments may traverse the routes of the routing tree from a set of starting nodes of the routing tree to one or more leaf nodes of the routing tree, as indicated by block 410. Some embodiments may comprehensively traverse each possible route of the routing tree from each viable starting node of the routing tree. For example, some embodiments may traverse the routes from a first node to each of the available leaf nodes, where each respective route of the routing tree starts at this first node and ends at a respective leaf node of the routing tree.

When traversing the routes of the routing tree, various types of routing operations may be considered as separate routes. For example, each of the route options to a different gateway may be considered a separate route in a routing tree. Furthermore, the execution of one or more operations during the routing of a message may be considered a separate path in a routing tree. For example, some embodiments may determine that, at a particular node through which a message may travel, the message may be sent to a first gateway, sent to a second gateway, paused until an authentication operation is successfully completed, or completely rejected. Some embodiments may model each of these four different outcomes as their own path in a routing tree for the message.

In some embodiments, the nodes may include node weights, where the node weights may represent or indicate the parameters used to determine which path that a message will take or is likely to take as it travels through a route. For example, some embodiments may generate a routing tree that indicates a message node that determines whether to send an authentication request to a designated directory server. Furthermore, when training the prediction layer some embodiments may train the prediction layer to use a probabilistic method for authentication operations, where this probabilistic method may treat incoming messages differently based on a reward value generated from a node weight. For example, some embodiments may receive a first message and calculate a reward value by randomly generating a candidate value between zero and one, determining whether this candidate value exceeds a node weight, and then determining a reward value that indicates whether the candidate value exceeds the node weight or does not exceed the node weight. In cases where the reward value indicates that the node weight is exceeded, some embodiments may then send the message to a gateway. In contrast, if the reward value indicates that the node weight is not exceeded, some embodiments may send the message to a designated directory server to perform one or more authentication operations. It should be understood that, in view of a randomly generated candidate value, some embodiments may determine the value by increasing or decreasing the candidate value based on additional information associated with the message or content and the message itself.

In some embodiments, a message node may include an initial message-receiving device, an intermediate device between the message route-receiving device and a downstream server, or another device or computer system described in this disclosure. The message node may rely on a node weight to determine whether to perform one or more authentication operations, where the node weight may be a machine learning model parameter, otherwise related to the machine learning model parameters, or be or relate to another parameter stored in or accessible to the node. As described elsewhere in this disclosure, some embodiments may configure a machine learning model to perform an authentication operation when receiving a message that satisfies a set of criteria, such as receiving a message lacking one or more values indicating authentication.

Some embodiments may determine a set of performance metrics associated with the routing tree based on the set of routes, as indicated by block 414. Some embodiments may use the determined set of performance metrics for a single route to determine a total performance metric representing an aggregated value for a respective route determined from the individual performance metrics associated with each visited node or sub-route of the respective route. Some embodiments may determine a set of performance metrics associated with the routing tree by, to determine a respective total performance metric of the set of performance metrics associated with the respective route based on weights associated with nodes of the routing tree.

Some embodiments may use one or more various types of criteria for target route selection. Some embodiments may then use these total latency values to select a candidate route as a target route based on a determination that the candidate route is associated with the least total latency value. For example, some embodiments may use performance metrics when determining which route to select as a target route through which a message is directed and processed, where the performance metrics may include throughputs, signal reliability, signal quality, noise measurements, etc.

When determining performance metrics, some embodiments may use measurements of network performance or computing performance. For example, some embodiments may use latency values as part of performance metrics used to evaluate routes through a node. Some embodiments may use one or more measured latency values associated with the traversal of a message through a network to predict future latency values using the route options of that route. For example, some embodiments may determine a mean average value or median latency value through multiple measurements of route options from one node to another or from the start of an operation to the end of the operation. Some embodiments may then use this mean average value or median latency value as a latency value for the node in a routing tree. Some embodiments may use similar operations or other route options for the node with respect to communicating the message to a gateway, performing authentication operations, or for performing described in this disclosure. Some embodiments may then collectively determine a total latency for each path by summing the individual latency values through a route or determine a likely range of latency values based on distributions of latency values for each path through the route. Some embodiments may then determine total latency values for each leaf node of a routing tree by, for each respective subset of latency metrics of a respective route of the routing tree, determining a respective latency metric for each respective node of the routing tree.

Some embodiments may apply a centralized objective function to rank the various outcomes represented by routing tree states. Some embodiments may further perform batch scoring of operations to generate predictions. For example, in the context of batch systems, some embodiments may use an objective function to predict a conversion (e.g., as calculated based on a probability of a message being authenticated & authorized, an amount associated with the message, and a constant (e.g., 20%, 2%, some other percentage between 0% and 100%)). Alternatively, some embodiments may determine other types of values, such as values indicating a malicious activity, latency, profit, etc., using one or more probability values or measured metric values. Some embodiments may use another machine learning model to predict probability values. For example, some embodiments may use a multi-task machine learning model to determine a probability of authentication based on historic authentication values.

Some embodiments may permit a user to tune the objective function for personal use. For example, some embodiments may permit a user that is very latency-sensitive to tune a latency threshold by specifying, in a dashboard or another user interface, a threshold or a modification to an objective function that would impact route decisions. In contrast to separated decision processes for separate actions during message routing, an integrated decision process permits the easy, real-time or near-real-time determination of an objective function for final outcomes. Such operations may prevent the technical difficulty of node-by-node or decision-by-decision analysis from interfering with a user's ability to define their own optimal outcome.

In addition to other latency contributions, some embodiments may consider the latency impacts of different machine learning models when performing scoring operations. For example, some embodiments may use a prediction layer that includes an XGBoost model that requires between 25 milliseconds (ms) to 35 ms to execute when used to select a route for a message. Alternatively, some embodiments may use a prediction layer that includes a deep neural network that requires 55 to 75 ms to execute when used to select a route for a message. It should be understood, however, that the use of a more sophisticated model in lieu of a less sophisticated model (e.g., using a deep neural network in lieu of an XGBoost model) may be more advantageous when applied to more complex networks.

Some embodiments may include operations in a routing tree to create waiting periods or enforced delays and operations. Some embodiments may treat these waiting periods or enforced delays as additional route options within a routing tree. For example, some embodiments may generate a routing tree having a node at which a computer system may determine whether to perform a delay or to move a message to a next node. In some cases, an optimal value may be obtained by enforcing a delay in message transmission for a delay interval in response to detecting one or more features of the message or associated with the message that would benefit from this delay. Some embodiments may determine the delay based on a timing factor, where the timing factor may be sent or retrieved based on an association with a computer system, an application, a client device, network configuration, a quality or feature associated with the message, etc. For example, some embodiments may first determine an aggregate performance metric (e.g., a total latency value for a route, a total gas score for a route, a network resource consumption score for the route, etc.).

Some embodiments may determine whether a message includes a network token that satisfies a set of criteria (e.g., authentication criteria) or perform operations to induce the creation of a network token for a message. For example, some embodiments may cause the generation and use of a network token for a message despite such operations taking longer for the message to be communicated or processed. Some embodiments may cause the generation or use of the network token based on a determination that the use of the network token may be more favorable to an outcome score associated with a route. For example, some embodiments may determine that an expected profit from using a network token is that not using the network token despite the fact that the use of the network token will cause a message delay and additional upfront computing resource use. Furthermore, some embodiments may determine a timing factor that is based on this expected profit, where an increase in the expected profit may result in the selection of a timing factor that increases the downstream delay interval. By forcing a delay interval for a network token or based on other criteria, some embodiments may choose a different route for a message route and increase a total outcome score associated with that route.

Some embodiments may perform other types of authentication operations or determine an outcome score for different possible routes including the execution of authentication operations. For example, some embodiments may determine that a first node of a routing tree includes a node weight that is associated with a user-prompted authentication operation to send an authentication message to a server to authenticate the message. The authentication operation may include sending the authentication message for an application program interface parameter. In some embodiments, the node weight may be configured to cause a routing operation to always include this user-prompted authentication operation. For example, some embodiments may receive a request from a user that includes an API parameter to perform authentication. Some embodiments may then train or otherwise configure a set of prediction layers to recommend that a system perform the authentication operation.

It should be understood that other reasons may cause the initiation of a delay interval. For example, some embodiments may determine a set of estimated latency values associated with a set of routes for a routing tree. Some embodiments may then determine a maximum estimated latency value from the set of estimated latency values and use this value to then determine a delay interval, where exceeding this delay interval indicates that a message has not been timely received or causes a rejection of the message for exceeding the delay interval. For example, some embodiments may determine that a maximum estimated latency value is equal to 5500 ms. Some embodiments may then provide this latency value to a function to determine a delay interval, such as a function that multiplies or adds to the maximum estimated latency value, and where the output of the function is set to be the delay interval.

Some embodiments may train a set of prediction layers or another type of prediction model based on the determined set of performance metrics, as indicated by block 418. Some embodiments may use the set of routes and the set of performance metrics associated with those routes to train a set of prediction layers or another type of machine learning model to predict performance metrics from a route. For example, some embodiments may use each routing tree state of the routing she states of the routing tree as a training input for a machine learning model, where a target of the training is the corresponding output total performance metric for that routing tree state. For example, some embodiments may traverse a routing tree with a set of fifty routes and determine a corresponding set of fifty outcome performance metrics. Some embodiments may train a set of prediction model layers, such as a neural network that includes a set of neural network layers, to predict the corresponding set of performance metrics for each of the respective fifty routes.

In some embodiments, one or more route options of a routing tree may include route options representing gateways or actions taken by the gateways. For example, some embodiments may generate a routing tree that includes a first route for a first gateway and a second route for a second gateway. At a second node representing the selection of the first gateway, route options may include a first location-searching operation (e.g. obtaining an inferred zip code), determining what type of credentials to use (e.g., using a PAN or an NT), a card expiration date (e.g., an inferred date), or how to classify the message initiator (e.g., as a recurring message initiator or a one-time message initiator (e.g., “cardholder”)). After performing a set of training operations, some embodiments may determine that an optimal route may include parameters indicating the use of an operation to determine an inferred zip code operation, an operation to require the use of an NT, an operation to ignore expiration dates, and an operation to treat the message initiator as a recurring message initiator.

In some embodiments, training a machine learning model may also include using training data associated with actual messages. For example, some embodiments may receive messages that include or are provided in association with data related to an event causing the message, where some embodiments may use this data for training operations. For example, the message may be associated with event data that includes a selected action (e.g., “3DS”), an outcome code (e.g., “success” or “failed”), time since last executed (e.g., “1s,” “3m,” etc.), a recency related to the message, and whether certain operations were performed (e.g., “is_3DS_challenged: true”). Some embodiments may then use this event data for training operations to predict outcomes or whether selected actions should be taken.

Some embodiments may integrate additional operations during message routing determination or downstream operations. In some embodiments, a node of a routing tree may indicate or provide access to a sub-route that indicates a location determination operation. In some embodiments, the selection of a location determination operation may be included by default in a target route for a candidate message. For example, some embodiments may be configured to strongly favor searching for an inferred zip code or performing operations to obtain location information. For example, some embodiments may train a set of prediction layers of the prediction model to select a message route that causes the initiation of a location determination operation, where the location determination operation may result in retrieving location information. After completion of the training, a prediction model that uses this set of prediction layers may always or at least have a high likelihood of performing the location determination operation as part of determining a target route for a message.

After training the set of prediction layers or another type of prediction model, some embodiments may update one or more deployed models. In some embodiments, the deployed model may be hosted on the same set of servers or other types of computer devices used to generate or update the routing tree, used to determine performance metrics associated with the routing tree, or used to train the set of prediction layers. Alternatively, or additionally, some embodiments may update a deployed model hosted or be executed by another computer system, such as in another container in a cloud computing system or a set of client devices. For example, some embodiments may update one or more models on an application container based on one or more portions of the set of prediction layers trained using operations described for block 418 by transferring trained parameters via a network.

Some embodiments may deploy the trained set of prediction layers or trained prediction model, as indicated by block 424. In some embodiments, the deployment target may be a preconfigured destination. For example, be preconfigured to select a particular container or set of containers to update with model parameters corresponding with one or more prediction layers. Alternatively, some embodiments may obtain one or more input values indicating a deployment target. In some embodiments, a container executing on a cloud computing platform may be the deployment target. In response to a determination that the deployment target is on another computer system, some embodiments may deploy the updated prediction model parameters to the other computer system. Alternatively, in response to a determination that the deployment target is a client device, such as the client device that initially sent the update request, some embodiments may update the client device. Furthermore, some embodiments may deploy the set of prediction layers or other set parameters for a prediction model on the same set of computer systems used to train the prediction model.

When deploying a prediction model or portions of the model, some embodiments may determine which specific values to deploy based on other data. For example, a computer system may deploy a first set of prediction layers for a neural network to a first computing cluster associated with a first geographic region, where requests involving the use of the neural network are associated with the first computing cluster or this first geographic region. The computer system may deploy a second set of prediction layers in lieu of the first set of prediction layers to a second computing cluster with a second geographic region, where requests involving the use of the neural network are associated with the second computing cluster or this second geographic region. By using location information to selectively deploy models used to determine message routing operations, some embodiments may account for regional variations and capabilities specific to different regions. For example, a first region may be known to have access to four different gateways while a second region may be known to have access to three different gateways. A computer system may send, to a first cluster, a first prediction model that will predict outcomes associated with routing through each of the four different gateways. The computer system may send, to a second cluster, a second prediction model that will predict outcomes associated with routing through each of the three different gateways. As described elsewhere, some embodiments may then select a particular gateway in lieu of other gateways based on the node weights associated with each of the gateways.

Some embodiments may receive a new message to be routed, as indicated by block 430. In some embodiments, the client device may send a new message that is to be routed through a network, where the message may include text, characters, category values, etc.

Some embodiments may route the message through a target route based on the set of prediction layers or other trained machine learning model, as indicated by block 434. Some embodiments may use the set of prediction layers trained using operations described in this disclosure to determine which route has an optimal predicted performance metric and select this route for the path that a message should take. For example, some embodiments may determine, using a trained machine learning model, that a first route is associated with a latency equal to 50 milliseconds (ms) and that a second route is associated with a latency equal to 70 ms. In response, some embodiments may choose the first route as the target route through which to route one or more messages.

It should be understood that the input parameters of a message may influence which possible route through a routing tree will be selected as a target route. For example, a computer system may determine that a first parameter indicating pre-authentication is set for a first candidate message. After providing this first parameter and other parameters with a trained machine learning model, a trained machine learning model may choose a first routing path as the target route for the first candidate message. The computer system may determine that a second candidate message does not include an indicator of pre-authentication and, in response, use the same machine learning model to choose a second routing path as the target route for the second candidate message.

While the process 400 indicates that a server-side of a set of prediction layers or another server-side prediction model is used to determine a target route for a message, other embodiments are possible. For example, in the case that a set of prediction layers trained using operations described for block 418 is deployed to a client-side version of a predictive neural network, the client-side version of the predictive neural network may be used to determine a target route for a message.

Some embodiments may receive a set of follow-up operations based on the message route as indicated by block 440. A set of follow-up operations may include an authentication operation that requests a user provide a specific code, sends an indication message to a user device, or perform another type of authentication activity. For example, some embodiments may apply a 3DS operation to verify the identity of a user before permitting access to account values associated with that user.

Some embodiments may build a set of reports from data collected on the routes through which messages travel. For example, some embodiments may obtain a set of indicators of the nodes or route options taken by a message. Some embodiments may use the set of indicators and log the various routing decisions and their corresponding outcomes in a database. Some embodiments may then use this data to analyze individual decisions to see if they match with predicted outcomes. Some embodiments may then refine the weights or predictive metrics associated with a routing tree used to train a machine learning model or otherwise modify a machine learning model to form better predictions based on this data.

Some embodiments may be configured to attempt different routes when retrying to send a message through a network. For example, some embodiments may receive an indication that a first message has been rejected by a node. Some embodiments may then use a set of prediction layers of a machine learning model to select a next route for a version of the same first message or a different message from the same starting node. Some embodiments may select when retrying the same message or otherwise sending a message using the same starting node. For example, some embodiments may train a set of prediction layers or another portion of the prediction model to emulate a routing tree in which a first node weight is associated with a restart operation, which causes a restart of a message transmission route at a different node. Some embodiments may perform this operation in response to a detected failure state indicating that an initial version of the message was rejected. In some embodiments, this different node may be at a higher position in the routing tree with respect to the first node.

In cases where the decision tree is configured to attempt different routes when retrying to send a message through the network, some embodiments may experiment with different routing strategies by being configured to alternate between different possible routes for a message. For example, after determining that a first message had failed to reach a target destination after starting the message at a first node, some embodiments may select a first route that starts from a first higher node of a routing tree. After determining that a third message had failed to reach the same target destination after starting the third message at the first node, some embodiments may select a second route that starts at a second higher node of the routing tree. Various experimentation protocols may be implemented to explore different routes, such as Thompson Sampling, where the reward for exploring different routes may be based on reduced latency or other network metrics, or other types of aggregated metrics (e.g., a total cost of using a route, a total profit, etc.).

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, the client device 102 of FIG. 1 may be a smartphone, another type of mobile computing device, or a payment terminal. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. One or more non-transitory machine-readable media storing instructions may include instructions included on a single medium or instructions distributed across multiple media. For example, non-transitory media may include program instructions that are written as source files or written in machine-executable program code. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include one or more relational databases. Alternatively, or additionally, the set of databases or other electronic storage used in this disclosure may include one or more non-relational databases.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include one or more non-transitory machine-readable media (e.g., storage media) that electronically stores information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some, or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

### Enumerated Embodiments

The present techniques will be better understood with reference to the following enumerated clauses:

1. A method comprising determining a set of outcome values for message routes for a prediction layer and selecting a target route based on the set of outcome values.

2. A method comprising training, based on different routing tree states of a routing tree, a prediction layer to predict performance metrics by using the set of performance metrics as training data.

3. A method comprising: generating a routing tree based on a set of route options of the routing tree; determining a set of performance metrics associated with the routing tree by, for a respective route of the routing tree, traversing to a respective leaf node of the routing tree to determine a respective total performance metric of the set of performance metrics associated with the respective route based on weights associated with nodes of the routing tree.

4. A method comprising: generating a routing tree based on a set of route options of the routing tree; determining a set of performance metrics associated with the routing tree by, for a respective route of the routing tree, traversing to a respective leaf node of the routing tree to determine a respective total performance metric of the set of performance metrics associated with the respective route based on weights associated with nodes of the routing tree; training, based on different routing tree states, a prediction layer to predict performance metrics by using the set of performance metrics as training data; and updating, via a network, one or more models based on one or more portions of the prediction layer.

5. A method comprising: in connection with receiving instructions to train a predictive neural network, generating a routing tree based on a set of route options corresponding with a set of controlled nodes from a starting node of the routing tree; determining a set of performance metrics associated with the routing tree by traversing each respective route of the routing tree to a respective leaf node of the routing tree to determine a respective total performance metric associated with the respective route; training, based on routing tree states of the routing tree, the predictive neural network to predict performance metrics by using the set of performance metrics as training data; and pushing, via a network, the predictive neural network to a client device to update a client-side version of the predictive neural network, wherein the client device determines a target route for a candidate message using the client-side version of the predictive neural network.

6. A method comprising: generating a routing tree based on a set of route options of the routing tree; determining a set of performance metrics associated with the routing tree by, for a respective route of the routing tree, traversing to a respective leaf node of the routing tree to determine a respective total performance metric of the set of performance metrics associated with the respective route based on weights associated with nodes of the routing tree; training, based on different routing tree states of the routing tree, a prediction layer to predict performance metrics by using the set of performance metrics as training data; and deploying, via a network, one or more portions of the prediction layer to a computer system to update a distributed version of the prediction layer.

7. The method of any of the embodiments above, wherein a node of the routing tree indicates a sub-route that indicates a location determination operation, and wherein training the prediction layer comprises training the prediction layer to select a route that comprises the location determination operation.

8. The method of any of the embodiments above, wherein the prediction layer is a first prediction layer, and wherein the routing tree is a first routing tree, and wherein the weights are first weights, further comprising generating a second routing tree having second weights different from the first weights, and wherein pushing the first prediction layer to the computer system comprises: determining a geographic region associated with the computer system; and sending the first prediction layer in lieu of a second prediction layer based on the geographic region.

9. The method of any of the embodiments above, wherein a node of the routing tree comprises a node weight associated with triggering an operation to send an authentication request to a designated directory server, and wherein the distributed version of the prediction layer causes the computer system to perform the operation to send the authentication request.

10. The method of any of the embodiments above, wherein determining the set of performance metrics comprises determining a first subset of latency metrics by determining a respective latency metric for each respective node of the routing tree.

11. The method of any of the embodiments above, further comprising pushing a timing factor to the computer system, wherein the computer system performs operations to: determine an aggregate performance metric associated with a target route; and delay a message transmission for a delay interval determined based on the aggregate performance metric and the timing factor; and transmitting a message from the computer system during or after an end of the delay interval.

12. The method of any of the embodiments above, wherein a node of the routing tree is associated with a plurality of node weights associated with different gateways, and wherein the distributed version of the prediction layer causes the computer system to select a first gateway in lieu of other gateways of the different gateways based on a first node weight associated with the first gateway.

13. The method of any of the embodiments above, further comprising obtaining a set of indicators of nodes or route options taken by a message sent using the distributed version of the prediction layer.

14. The method of any of the embodiments above, wherein a first node of the routing tree comprises a first node weight associated with a restart operation to restart a message transmission route at a first higher node of the routing tree in response to a detected failure state, and wherein the computer system to performs the restart operation based on an output of the distributed version of the prediction layer.

15. The method of any of the embodiments above, wherein a first second of the routing tree comprises a second node weight associated with restarting the message transmission route at a second higher node of the routing tree in response to the detected failure state, and wherein the computer system performs the restart operation by starting at the first higher node in lieu of the second higher node based on the output of the distributed version of the prediction layer.

16. The method of any of the embodiments above, further comprising: determining a delay interval based on a set of estimated latency values associated with a set of routes of the routing tree; and pushing the delay interval to a computer system hosting the one or more models.

17. The method of any of the embodiments above, wherein a first node of the routing tree comprises a first node weight associated with an user-prompted authentication operation to send an authentication message to a server in response to receiving a request for an application program interface parameter, and wherein a computer system performs the user-prompted authentication operation using the one or more models after receiving a user request for the application program interface parameter based on the first node weight.

18. The method of any of the embodiments above, wherein a node of the routing tree indicates a sub-route that indicates a location determination operation, and wherein training the prediction layer comprises training the prediction layer to select a route that comprises the location determination operation.

19. The method of any of the embodiments above, wherein the prediction layer is a first prediction layer, and wherein the routing tree is a first routing tree, and wherein the weights are first weights, further comprising generating a second routing tree having second weights different from the first weights, and wherein updating the one or more models comprises: determining a geographic region associated with a computer system or an incoming message sent to the computer system; and sending the first prediction layer in lieu of a second prediction layer based on the geographic region.

20. The method of any of the embodiments above, wherein a node of the routing tree comprises a node weight associated with triggering an operation to send an authentication request to a designated directory server, the operations comprising determining a reward value based on the node weight, wherein training the prediction layer comprises training the prediction layer to instruct triggering the operation to send the authentication request based on the reward value.

21. The method of any of the embodiments above, wherein determining the set of performance metrics comprises determining a first subset of latency metrics by determining a respective latency metric for each respective node of the routing tree.

22. The method of any of the embodiments above, wherein a node of the routing tree is associated with a plurality of node weights associated with different gateways, and wherein a computer system selects a first gateway in lieu of other gateways of the different gateways based on a first node weight associated with the first gateway.

23. The method of any of the embodiments above, further comprising obtaining a set of indicators of nodes or route options taken by a message sent using the one or more models.

24. A tangible, non-transitory, machine-readable medium storing instructions that, when executed by a data processing apparatus, cause the data processing apparatus to perform operations comprising those of any of embodiments 1-23.

25. A system comprising one or more processors; and memory storing instructions that, when executed by the processors, cause the processors to effectuate operations comprising those of any of embodiments 1-23.

26. A system comprising means for performing any of embodiments 1-23.

What is claimed is:

1. A system for efficiently determining a network route through one or more networks by mapping aggregated performance metrics through controlled nodes, comprising one or more non-transitory media storing program instructions that, when executed by one or more processors, causes the one or more processors to perform operations comprising:
in connection with receiving instructions to train a predictive neural network, generating a routing tree based on a set of route options corresponding with a set of controlled nodes from a starting node of the routing tree;
determining a set of performance metrics associated with the routing tree by traversing each respective route of the routing tree to a respective leaf node of the routing tree to determine a respective total performance metric associated with the respective route;
training, based on routing tree states of the routing tree, the predictive neural network to predict performance metrics by using the set of performance metrics as training data; and
pushing, via a network, the predictive neural network to a client device to update a client-side version of the predictive neural network, wherein the client device determines a target route for a candidate message using the client-side version of the predictive neural network.

2. A method for comprising:
generating a routing tree based on a set of route options of the routing tree;
determining a set of performance metrics associated with the routing tree by, for a respective route of the routing tree, traversing to a respective leaf node of the routing tree to determine a respective total performance metric of the set of performance metrics associated with the respective route based on weights associated with nodes of the routing tree;
training, based on different routing tree states of the routing tree, a prediction layer to predict performance metrics by using the set of performance metrics as training data; and
deploying, via a network, one or more portions of the prediction layer to a computer system to update a distributed version of the prediction layer.

3. The method of claim 2, wherein a node of the routing tree indicates a sub-route that indicates a location determination operation, and wherein training the prediction layer comprises training the prediction layer to select a route that comprises the location determination operation.

4. The method of claim 2, wherein the prediction layer is a first prediction layer, and wherein the routing tree is a first routing tree, and wherein the weights are first weights, further comprising generating a second routing tree having second weights different from the first weights, and wherein pushing the first prediction layer to the computer system comprises:
determining a geographic region associated with the computer system; and
sending the first prediction layer in lieu of a second prediction layer based on the geographic region.

5. The method of claim 2, wherein a node of the routing tree comprises a node weight associated with triggering an operation to send an authentication request to a designated directory server, and wherein the distributed version of the prediction layer causes the computer system to perform the operation to send the authentication request.

6. The method of claim 2, wherein determining the set of performance metrics comprises determining a first subset of latency metrics by determining a respective latency metric for each respective node of the routing tree.

7. The method of claim 2, further comprising pushing a timing factor to the computer system, wherein the computer system performs operations to:
determine an aggregate performance metric associated with a target route; and
delay a message transmission for a delay interval determined based on the aggregate performance metric and the timing factor; and
transmitting a message from the computer system during or after an end of the delay interval.

8. The method of claim 2, wherein a node of the routing tree is associated with a plurality of node weights associated with different gateways, and wherein the distributed version of the prediction layer causes the computer system to select a first gateway in lieu of other gateways of the different gateways based on a first node weight associated with the first gateway.

9. The method of claim 2, further comprising obtaining a set of indicators of nodes or route options taken by a message sent using the distributed version of the prediction layer.

10. The method of claim 2, wherein a first node of the routing tree comprises a first node weight associated with a restart operation to restart a message transmission route at a first higher node of the routing tree in response to a detected failure state, and wherein the computer system to performs the restart operation based on an output of the distributed version of the prediction layer.

11. The method of claim 10, wherein a first second of the routing tree comprises a second node weight associated with restarting the message transmission route at a second higher node of the routing tree in response to the detected failure state, and wherein the computer system performs the restart operation by starting at the first higher node in lieu of the second higher node based on the output of the distributed version of the prediction layer.

12. One or more non-transitory machine-readable media storing program instructions that, when executed by one or more processors, causes the one or more processors to perform operations comprising:
generating a routing tree based on a set of route options of the routing tree;
determining a set of performance metrics associated with the routing tree by, for a respective route of the routing tree, traversing to a respective leaf node of the routing tree to determine a respective total performance metric of the set of performance metrics associated with the respective route based on weights associated with nodes of the routing tree;
training, based on different routing tree states, a prediction layer to predict performance metrics by using the set of performance metrics as training data; and
updating, via a network, one or more models based on one or more portions of the prediction layer.

13. The one or more non-transitory machine-readable media of claim 12, further comprising:
determining a delay interval based on a set of estimated latency values associated with a set of routes of the routing tree; and
pushing the delay interval to a computer system hosting the one or more models.

14. The one or more non-transitory machine-readable media of claim 12, wherein a first node of the routing tree comprises a first node weight associated with an user-prompted authentication operation to send an authentication message to a server in response to receiving a request for an application program interface parameter, and wherein a computer system performs the user-prompted authentication operation using the one or more models after receiving a user request for the application program interface parameter based on the first node weight.

15. The one or more non-transitory machine-readable media of claim 12, wherein a node of the routing tree indicates a sub-route that indicates a location determination operation, and wherein training the prediction layer comprises training the prediction layer to select a route that comprises the location determination operation.

16. The one or more non-transitory machine-readable media of claim 12, wherein the prediction layer is a first prediction layer, and wherein the routing tree is a first routing tree, and wherein the weights are first weights, further comprising generating a second routing tree having second weights different from the first weights, and wherein updating the one or more models comprises:
determining a geographic region associated with a computer system or an incoming message sent to the computer system; and
sending the first prediction layer in lieu of a second prediction layer based on the geographic region.

17. The one or more non-transitory machine-readable media of claim 12, wherein a node of the routing tree comprises a node weight associated with triggering an operation to send an authentication request to a designated directory server, the operations comprising determining a reward value based on the node weight, wherein training the prediction layer comprises training the prediction layer to instruct triggering the operation to send the authentication request based on the reward value.

18. The one or more non-transitory machine-readable media of claim 12, wherein determining the set of performance metrics comprises determining a first subset of latency metrics by determining a respective latency metric for each respective node of the routing tree.

19. The one or more non-transitory machine-readable media of claim 12, wherein a node of the routing tree is associated with a plurality of node weights associated with different gateways, and wherein a computer system selects a first gateway in lieu of other gateways of the different gateways based on a first node weight associated with the first gateway.

20. The one or more non-transitory machine-readable media of claim 12, further comprising obtaining a set of indicators of nodes or route options taken by a message sent using the one or more models.
